(19) United States
(12) Patent Application Publication
(10) Pub. No.: US 2026/0209543 A1
(43) Pub. Date: Jul. 23, 2026

(54) COATING COMPOSITION COMPRISING A BINDER POLYMER OBTAINABLE BY COPOLYMERIZING A MONOMER MIXTURE COMPRISING A VINYL MONOMER AND A BUTENOLIDE MONOMER

(71) Applicant: AKZO NOBEL COATINGS INTERNATIONAL B.V., Amsterdam (NL)

(72) Inventors: Mathieu Louis Philippe Lepage, Amsterdam (NL); Bernard Lucas Feringa, Amsterdam (NL); Johannes George Hendrik Hermens, Amsterdam (NL); Keimpe Jan Van Den Berg, Amsterdam (NL); Niels Elders, Amsterdam (NL)

(21) Appl. No.: 19/137,164

(22) PCT Filed: Dec. 15, 2023
(86) PCT No.: PCT/EP2023/086163

§ 371 Date: Jun. 9, 2025

(30) Foreign Application Priority Data
Dec. 16, 2022 (EP) 22214133.5

(51) Int. Cl. C09D 147/00; C08F 220/18; C08F 226/10; C08F 234/02; C09D 5/02; C09D 139/06

(52) U.S. Cl. CPC C09D 147/00; C08F 220/1809; C08F 226/10; C08F 234/02; C09D 5/02; C09D 139/06

(57) ABSTRACT

A coating composition comprising a binder polymer, which binder polymer is obtainable by copolymerizing a monomer mixture comprising a vinyl monomer M1 and a butenolide monomer M2,
wherein the vinyl monomer M1 has a difference in ¹³C chemical shift between the α-C and β-C of the vinyl group of at least 25 ppm,
and wherein the butenolide monomer M2 is a substituted-5-hydroxy-2(5H)-furanone of general formula (I):

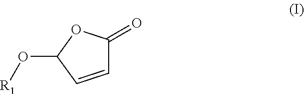

wherein R¹ is any one of:
—C(O)R², —C(O)OR², —C(O)NR²R³, —S(O)R², —S(O₂)R², —C(O)SR², —C(S)SR² and —C(S)NR²R³,
wherein R² is alkyl or aryl, and wherein R³ is hydrogen, alkyl or aryl, or wherein R² and R³ together with the nitrogen atom through which they are linked form a nitrogen-containing cyclic heteroalkyl group or nitrogen-containing heteroaryl group.

The disclosure further relates to a substrate coated with a coating deposited from such coating composition to a binder polymer and to novel butenolide monomers M2.

### CROSS REFERENCE TO RELATED APPLICATION

This application is a 35 U.S.C. § 371 national phase application of PCT Application No. PCT/EP2023/086163 (published as WO/2024/126828), filed Dec. 15, 2023, which claims the benefit of priority to EP Application No. 22214133.5, filed Dec. 16, 2022, each of which is incorporated herein by reference in their entirety.

### TECHNICAL FIELD

The present disclosure relates to a coating composition comprising a binder polymer, which binder polymer is obtainable by copolymerizing a monomer mixture comprising a vinyl monomer and a butenolide monomer, to a substrate coated with a coating deposited from such coating composition, to a binder polymer obtainable by copolymerizing a monomer mixture comprising a vinyl monomer, and to novel butenolide monomers.

### BACKGROUND

Polyacrylates or other addition polymers are widely used as film-forming polymers in paints and coatings. Film-forming polymers are also referred to as binder polymers since such polymers have the role to bind any particulate material such as color pigments and extender pigments together.

Polyacrylates or other addition polymers are typically prepared by radical polymerization of monomers with an ethylenically unsaturated group, such as an acrylic, methacrylic, or vinyl group. Examples of such monomers include acrylic acid, methacrylic acid, alkyl esters of (meth)acrylic acid, styrene, alkyl-substituted styrene, vinyl esters, and vinyl ethers. The monomers are usually prepared from petrochemical raw materials.

There is an increasing demand for chemical products prepared from renewable feedstock. Binder polymers at least partly prepared from renewable feedstock are known in the art. Alkyd resins for example comprise a relatively high content of fatty acids obtained from vegetable oil.

In WO2009/080599 is disclosed a process for preparing polymerizable ethylenically unsaturated macromonomers from vegetable oil that can be used to prepare an addition polymer for use in coating compositions.

Butenolides are ethylenically unsaturated furanoic compounds that can be prepared from carbohydrates, i.e. a renewable feedstock. Carbohydrate feedstock such as starch, cellulose or carbohydrate-containing bio-waste can be converted into furfural, hydroxymethylfurfural, or related furan derivatives by dehydration and then oxidized into lactones or other butenolides. Preparation of butenolides is for example described in Chapter II of J. C. de Jong, Asymmetric Diels-Alder reactions with 5-menthyloxy-2(5H)-furanones, Thesis University of Groningen, 2006, accessible via https://www.rug.nl/research/portal/en/publications/asymmetric-dielsalder-reactions-with-5menthyloxy25hfuranones(f0ab6c00-8c6c-4ccc-90aa-3ef05f759fa4).html.

Poskonin et al. have disclosed in Russian Journal of Organic Chemistry 35 (1999) 721-726 copolymers prepared by radical polymerization of 4-alkoxy-2-butenolide (5-alkoxy-2(5H)-furanone) and styrene, methyl methacrylate, or vinyl acetate. Use of such copolymers for synthesis of physiologically active substances is suggested. Poskonin et al. have further disclosed in Russian Journal of Organic Chemistry 35 (1997) 520-523 oligomers prepared by radical polymerization of 4-acetoxy-2-butenolide (5-acetoxy-2(5H)-furanone) and styrene, methyl methacrylate, or vinyl acetate. Number average molecular weights of from 1860 to 6460 were achieved.

WO2021/084066 describes copolymerization of 5-alkoxy-2(5H)-furanones with selected vinyl ethers or vinyl esters and the use of the resulting copolymers as a binder in a polymer coating composition.

WO2021259819 A1 describes a radiation curable coating composition comprising a 5-hydroxy- or 5-alkoxy-(5H)— furanone compound A and a compound B having at least two vinyl ether or vinyl ester groups, such that the ratio of vinyl moieties on compound B to furanone moieties on compound A is at least 0.5.

Trost and Toste have disclosed in J. Am. Chem. Soc. 2003, 125, 3090-3100 two butenolide compounds: 2-tert-Butoxycarbonyloxy-5-oxo-2,5-dihydrofuran and 2-benzoyloxy-5-oxo-2,5-dihydrofuran with application in introducing chirality into synthesis of aflatotoxins.

Parijat Ray et al. “Synthesis of Bioacrylic Polymers from Dihydro-5-hydroxyl furan-2-one (2H-HBO) by Free and Controlled Radical Polymerization”, ACS OMEGA, vol. 3, no. 2, 20 Feb. 2018 (2018-02-20), pages 2040-2048 describes the reaction of dihydro-5-hydroxyl furan-2-one with methacrylic anhydride to form a methacrylic-dihydro-5-hydroxyl furan-2-one monomer. Subsequent homo- and co-polymerisation is carried out.

There is a need for coating compositions, which utilize binder polymers that can be obtained from renewable feedstock and which have higher reactivity and additional functionality compared with known binder polymers.

### SUMMARY

Accordingly, the disclosure provides in a first aspect a coating composition comprising a binder polymer, which binder polymer is obtainable by copolymerizing a monomer mixture comprising a vinyl monomer M1 and a butenolide monomer M2, wherein the vinyl monomer M1 has a difference in ¹³C chemical shift between the α-C and β-C of the vinyl group of at least 25 ppm, and wherein the butenolide monomer M2 is a substituted-5-hydroxy-2(5H)-furanone of general formula (I):

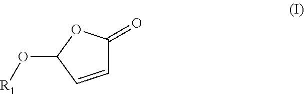

wherein R¹ is any one of:
—C(O)R², —C(O)OR², —C(O)NR²R³, —S(O)R², —S(O₂)R², —C(O)SR², —C(S)SR² and —C(S)NR²R³,
wherein R² is alkyl or aryl, and wherein R³ is hydrogen, alkyl or aryl, or wherein R² and R³ together with the nitrogen atom through which they are linked form a nitrogen-containing cyclic heteroalkyl group or nitrogen-containing heteroaryl group.

In a second aspect, the disclosure provides a substrate coated with a coating deposited from a coating composition as defined herein.

In a third aspect, the disclosure provides a binder polymer obtainable by copolymerizing a monomer mixture comprising a vinyl monomer M1 as defined herein and a butenolide monomer M2 as defined herein.

In a fourth aspect, the disclosure provides a butenolide monomer which is a substituted-5-hydroxy-2(5H)-furanone of general formula (III):

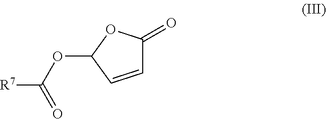

wherein R⁷ is any one of:
C₂-C₂₀ alkyl, —OCHR⁸R⁹, —NR⁸R⁹, —SR₉, wherein R³ is alkyl or aryl, and wherein R⁹ is hydrogen, alkyl or aryl, or when R⁷ is —NR⁸R⁹ R⁸ and R⁹ together with the nitrogen atom through which they are linked form a nitrogen-containing cyclic heteroalkyl group or nitrogen-containing heteroaryl group.

The binder polymer has been found to provide a tack-free coating film with good hardness properties if applied to a substrate and allowed to dry.

The binder polymer has a polymer backbone with functionality which advantageously can provide possibilities for crosslinking.

### DETAILED DESCRIPTION

The coating composition according to the disclosure binder polymer comprises a binder polymer, which binder polymer is obtainable by copolymerizing a monomer mixture comprising a vinyl monomer M1 and a butenolide monomer M2.

As used herein difference in ¹³C chemical shift between the α-C and β-C of the vinyl group can be determined from the chemical shift as reported in the Spectral Database for Organic Compounds (https://sdbs.db.ajst.go.jp/sdbs/cgi-bin/direct_frame_top.cgi), managed by the National Institute of Advanced Industrial Science and Technology.

As used herein an alkyl radical may be branched, unbranched, linear or cyclic. The alkyl radical may be saturated or unsaturated. It may be substituted or unsubstituted. An alkyl radical typically contains from 1 to 20 carbon atoms, in particular 1 to 12 carbon atoms, 1 to 6 carbon atoms or 1 to 4 carbon atoms. An alkyl radical may contain from 2 to 20 carbon atoms, in particular from 2 to 12 carbon atoms, 2 to 6 carbon atoms or 2 to 4 carbon atoms. An alkyl radical may contain from 1 to 3 carbon atoms, for example 1, 2 or 3 carbon atoms. Examples of alkyl radials are methyl, ethyl, n-propyl, isopropyl, n-butyl, tert-butyl, sec-butyl, isobutyl, hexyl, lauryl, oleyl and cyclohexyl.

As used herein, cycloalkyl means a cyclic alkyl radical. Cyclic heteroalkyl means a cyclic heteroalkyl radical wherein at least one carbon in the cycle is substituted with a heteroatom. A heteroatom may be nitrogen, oxygen or another atom other than carbon. A cyclic heteroalkyl radical may be a nitrogen-containing cyclic heteroalkyl.

As used herein aryl means an aromatic radical. An aryl radical may be substituted or unsubstituted. An aryl radical typically contains from 6 or 10 carbon atoms. An aryl radical may be phenyl or naphthyl, in particular phenyl. Heteroaryl means an aryl radical comprising a heteroatom, i.e. an atom other than carbon, in an aromatic ring. A heteroaryl radical may be substituted or unsubstituted. A heteroaryl radical typically contains from 5 to 12 carbon atoms. A typical hetero atom is oxygen or nitrogen.

M1 may have a difference in ¹³C chemical shift between the α-C and β-C of the vinyl group of at least 30 ppm, in particular at least 35 ppm.

In the coating composition of the present disclosure the vinyl monomer M1 may be: a vinyl compound of general formula (II)

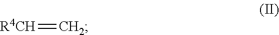

wherein R⁴ is any one of: —OR⁵, —OC(O)R⁵, —N(R⁶)C(O)R⁵, —N(R⁶)C(O)OR⁵, —N(R⁶)C(S)R⁵, —N(R⁶)C(S)OR⁵, —N(R⁶)C(S)SR⁵ and —SC(S)SR⁵,
wherein R⁵ is alkyl or aryl, and wherein R⁶ is hydrogen, alkyl or aryl, or wherein R⁵ and R⁶ together with the atoms through which they are linked form a nitrogen-containing cyclic heteroalkyl group or nitrogen-containing heteroaryl group.

In various embodiments, R⁴ is —OR⁵, —OC(O)R⁵ or —N(R⁶)C(O)R⁵. In particular, when R⁴ is —OR⁵, R⁵ may be alkyl. When R⁴ is —OR⁵, R⁵ may in particular be linear C₁-C₁₂ alkyl. When R⁴ is —NR⁶C(O)R⁵, R⁶ may be hydrogen and R⁵ may be C₁-C₁₂ alkyl, or in particular, R⁵ and R⁶ together with the atoms through which they are linked form a nitrogen-containing cyclic heteroalkyl group, in particular a C₅-C₇ nitrogen containing cyclic heteroalkyl group.

In various embodiments, R⁴ is —C(O)R⁵, wherein R⁵ is C₂-C₁₂ alkyl or aryl. In particular, R⁵ may be C₂-C₆ alky or phenyl.

In various embodiments, vinyl monomer M1 is a vinyl ether, a vinyl ester or an N-vinyl monomer. M1 may be n-butyl vinyl ether, iso-butyl vinyl ether, cyclohexyl vinyl ether, phenyl vinyl ether, 2-ethylhexyl vinyl ether, n-dodecyl vinyl ether, 4-hydroxybutyl vinyl ether, vinyl neodecanoate, vinyl neononanoate, N-vinylpyrrolidone, N-vinyl imidazole, N-vinyl-formamide, N-vinyl-pyrrole, N-vinylcaprolactam or a mixture of two or more thereof. In various embodiments, vinyl monomer M1 is vinyl neodecanoate or a mixture of vinyl neodecanoate and vinyl neononanoate.

In the butenolide monomer M2 of the coating composition of the present disclosure R¹ is any one of:

—C(O)R², —C(O)OR², —C(O)NR²R³, —S(O)R², —S(O₂)R², —C(O)SR², —C(S)SR² and —C(S)NR²R³, wherein R² is alkyl or aryl, and wherein R³ is hydrogen, alkyl or aryl, or wherein R² and R³ together with the nitrogen atom through which they are linked from a nitrogen-containing cyclic heteroalkyl group or nitrogen-containing heteroaryl group. In various embodiments, R¹ may be any one of —C(O)R², —C(O)OR², —C(O)NR²R³.

In the butenolide monomer M2 of the coating composition of the present disclosure R² may be C₁-C₂₀ alkyl, C₅-C₇ cycloalkyl or phenyl. In various embodiments, R² may be C₁-C₁₂ alkyl. In another embodiment, R² may be C₅-C₇ cycloalkyl. In another embodiment R² may be phenyl.

In various embodiments, R¹ is —C(O)R²; wherein R² is C₂-C₁₂ alkyl or aryl. In particular, R² may be C₂-C₆ alkyl or phenyl.

In various embodiments, R³ may be hydrogen or C₁-C₂₀ alkyl. In particular, R³ may be hydrogen or C₁-C₁₂ alkyl, for example R³ may be hydrogen.

In various embodiments, the binder polymer of the present disclosure is obtainable by copolymerizing a monomer mixture comprising a vinyl monomer M1 and a butenolide monomer M2 wherein the vinyl monomer M1 has a difference in ¹³C chemical shift between the α-C and β-C of the vinyl group of at least 25 ppm and wherein the butenolide monomer M2 is a substituted-5-hydroxy-2(5H)-furanone of general formula (I):

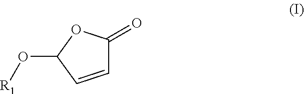

wherein R¹ is any one of: —C(O)OR², —C(O)NR²R³, —S(O)R², —S(O₂)R², —C(O)SR², —C(S)SR², —C(S)NR²R³, and —C(O)R¹¹, wherein R² is alkyl or aryl, R³ is hydrogen, alkyl or aryl, or R² and R³ together with the nitrogen atom through which they are linked form a nitrogen-containing cyclic heteroalkyl or nitrogen-containing heteroaryl group, and wherein R¹¹ is aryl or C₂-C₂₀ alkyl.

In various embodiments, R¹ may be any one of —C(O) R¹¹, —C(O)OR², —C(O)NR²R³.

In various embodiments the binder polymer of the present disclosure R² is C₁-C₁₂ alkyl, C₅-C₇ cycloalkyl or phenyl. In various embodiments, R² may be C₂-C₁₂ alkyl. R² may be branched or unbranched, substituted or unsubstituted C₁-C₁₂ alkyl. In another embodiment, R² may be C₅-C₇ cycloalkyl. In another embodiment R² may be phenyl.

R¹¹ may be C₂-C₁₂ alkyl, C₅-C₇ cycloalkyl or phenyl. In various embodiments, R¹¹ may be C₂-C₁₂ alkyl. R¹¹ may be branched or unbranched, substituted or unsubstituted C₂-C₁₂ alkyl. In another embodiment, R¹¹ may be C₅-C₇ cycloalkyl. In another embodiment R¹¹ may be phenyl.

In various embodiments, R¹ is —C(O)R¹¹; wherein R¹¹ is aryl or C₂-C₁₂ alkyl. In particular, R¹¹ may be C₂-C₆ alkyl or phenyl.

In various embodiments, R³ may be hydrogen or C₁-C₁₂ alkyl. In particular, R³ may be hydrogen.

In the binder polymer of the present disclosure the vinyl monomer M1 may be: a vinyl compound of general formula (II)

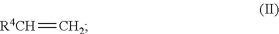

wherein R⁴ is any one of:
—OR⁵, —N(R⁶)C(O)R⁵, —N(R⁶)C(O)OR⁵, —NR⁶C(S)R⁵, —NR⁶C(S)OR⁵, —NR⁶C(S)SR⁵, —SC(S)SR⁵, and —OC(O)R¹²,
wherein R⁵ is alkyl or aryl, R⁶ is hydrogen, alkyl or aryl, or R⁵ and R⁶ together with the atoms through which they are linked form a nitrogen-containing cyclic heteroalkyl group or nitrogen-containing heteroaryl group, and wherein R¹² is aryl or C₂-C₂₀ alkyl.

R⁴ may be —OR⁵, —OC(O)R¹² or —N(R⁶)C(O)R⁵. In particular, when R⁴ is —OR⁵, R⁵ may be alkyl. When R⁴ is —OR⁵, R⁵ may in particular be linear C₁-C₁₂ alkyl. When R⁴ is —NR⁶C(O)R⁵, R⁶ may be hydrogen and R⁵ may be C₁-C₁₂ alkyl, or in particular, R⁵ and R⁶ together with the atoms through which they are linked form a nitrogen-containing cyclic heteroalkyl group, in particular a C₅-C₇ nitrogen containing cyclic heteroalkyl group.

In various embodiments, R⁴ is —OC(O)R¹², wherein R¹² is aryl or C₂-C₁₂ alkyl. In particular, R¹² may be C₂-C₆ alkyl or phenyl.

The monomer mixture may have any suitable molar ratio of vinyl monomer M1 to butenolide monomer M2. In various embodiments, the molar ratio of vinyl monomer M1 to butenolide monomer M2 may be in the range of from 1:10 to 10:1, in particular from 1:5 to 5:1, for example from 1:3 to 3:1, from 1:2 to 2:1, or even from 1:1.5 to 1.5:1. In various embodiments, the coating composition is an aqueous liquid coating composition comprising the binder polymer emulsified in an aqueous phase.

In various embodiments, the monomer mixture may comprise further ethylenically unsaturated monomers other than vinyl monomer M1 and butenolide monomer M2 that can be copolymerized by radical polymerization. Examples of such further monomers are acrylic acid, methacrylic acid, alkyl esters of (meth)acrylic acid, styrene, methylene malonates, itaconic acid, vinyl acetate, divinyl ethers such as ethyleneglycol divinyl ether, diethyleneglycol divinyl ether, triethyleneglycol divinyl ether, 1,4-butanediol divinyl ether, and trivinyl ethers such as trimethylolpropane trivinyl ether. The presence of divinyl ethers in the monomer mixture provides a binder polymer with crosslinking functional groups.

In various embodiments, the monomer mixture comprises less than 50 mol % of further ethylenically unsaturated monomers, for example less than 30 mol %, less than 20 mol %, or even less than 10 mol %. In various embodiments, the monomer mixture comprises from 1 to 50 mol % of further ethylenically unsaturated monomers, for example from 2 to 30 mol %, particularly 5 to 20 mol %.

In another embodiment, the monomer mixture is free of further ethylenically unsaturated monomers.

The copolymerizing is a radical polymerization process. Conditions that allow the monomers to copolymerize into an addition polymer by radical polymerization are well-known in the art. Suitable conditions typically include the presence of an initiator.

The co-polymerization may be carried out in an organic solvent (solvent polymerization). In solvent polymerization, the monomer mixture is dissolved in a suitable organic solvent, heated to the desired reaction temperature and a suitable initiator is added in a suitable amount. Typically, the temperature during solvent polymerization is in the range of from 50° C. to 180° C., for example from 70° C. to 160° C. It will be appreciated that the optimum polymerization temperature will depend on the decomposition temperature of the initiator used and the boiling temperature of the any monomers at the pressure at which the polymerization is carried out. The monomer mixture may be dissolved in any suitable solvent during the copolymerization. Suitable organic solvents are solvents in which all monomers in the monomer mixture and the resulting copolymer dissolve at polymerization conditions. Typically, the organic solvent is an oxygenated organic solvent such as for example an alcohol, glycol ether, glycol ester, alkyl acetate, ketone, ester, or glycol ether/ester. For example, the solvent is a glycol ether or an alkyl acetate. 1-Methoxy-2-propanol and butyl acetate are particular solvents.

Alternatively, the copolymerization may be carried out as an emulsion polymerization process wherein monomers are emulsified in an aqueous phase and then copolymerized. Emulsion polymerization may be carried out at a temperature in the range of from 15° C. to 90° C.

Any suitable initiator may be used. Suitable initiators are known in the art and include organic peroxides and azo initiators. Examples of azo initiators include azobisisobutyronitrile (AIBN) and 2,2′-azodi(2-methylbutyronitrile) (AMBN). Examples of suitable organic peroxides include tert-butyl peroxy-3,5,5-trimethylhexanoate, benzoyl peroxide, lauroyl peroxide, di-t-butyl peroxide, acetyl peroxide, t-butyl peroxy 2-ethylhexyl carbonate, t-butyl peroxy octanoate, t-amyl peroxy octanoate, and t-butyl peroxy benzoate. The initiator may be added in any suitable amount, typically up to 6 mol % based on the total moles of ethylenically unsaturated monomers, for example in the range of from 1 to 4 mol %. The total amount of initiator may be added in two or three steps, i.e. a first amount at the start of the polymerization and a further amount during the polymerization reaction.

Optionally, a chain transfer agent is used during polymerization. Any suitable chain transfer agent may be used in a suitable amount. Suitable chain transfer agents are known in the art and include methyl mercaptopropionate, 1-dodecanethiol, 1-octanethiol, thioglycolic acid, 2-hydroxy-1-ethanethiol, and butenediol.

The copolymerization may be carried out batch-wise, i.e. by dosing all monomers and initiator at the start of the polymerization, or by gradually dosing part of the monomers and/or initiator during copolymerization, i.e. at so-called starve-fed conditions.

It has been found that the copolymer thus-obtained has properties that makes it suitable to be used as binder polymer in coating compositions. The binder polymer has a relatively high content of butenolide, a component that can be obtained from renewable feedstock.

In particular, a binder polymer with a glass transition temperature in the range of from −29° C. to +88° C., as measured by differential scanning calorimetry (DSC) according to ISO 11357-2 using a heating rate of 20 K/min, can be obtained. A further advantageous property of the binder polymer is that it has a polymer backbone with functionality (at the butenolide monomer) which can be used for crosslinking.

The coating composition may be a solvent-borne or waterborne liquid coating composition, or a powder coating composition, for example a liquid coating composition, particularly an aqueous liquid coating composition wherein a binder polymer is emulsified in an aqueous liquid phase.

The coating composition may comprise further ingredients commonly used in coating compositions such as color pigments, extender pigments, coalescing solvents, and one or more additives such as for example surfactants, defoaming agents, thickeners, leveling agents, and biocides.

In one aspect, the disclosure relates to a substrate coated with a coating deposited from a coating composition according to the disclosure. The substrate may be any suitable substrate, such as for example wood, polymer, composite, metal or mineral substrate. The substrate may be a primed or bare substrate.

R⁷ is any one of C₂-C₂₀ alkyl, —OCHR⁸R⁹, —NR⁸R⁹, —SR⁹, wherein R³ is alkyl or aryl, and wherein R⁹ is hydrogen, alkyl or aryl, or when R⁷ is —NR⁸R⁹, R⁸ and R⁹ together with the nitrogen atom through which they are linked form a nitrogen-containing cyclic heteroalkyl or nitrogen-containing heteroaryl group.

In various embodiments, in the butenolide compound of the present disclosure, R⁷ is C₂-C₁₂ alkyl. For example, R⁷ may be C₁₂H₂₃, ⁱPr or ⁿPr, in another embodiment, R⁷ is —O—C₁-C₃ alkyl, for example O^{t}Bu or OMe. In another embodiment, R⁷ is —NHR¹⁰, wherein R¹⁰ is cycloalkyl or C₁-C₁₂ alkyl. For example, R¹⁰ is cyclohexane or C₁₂H₂₅.

The butenolide of the present disclosure may be a compound of any one of formula (IV) to (XIII):

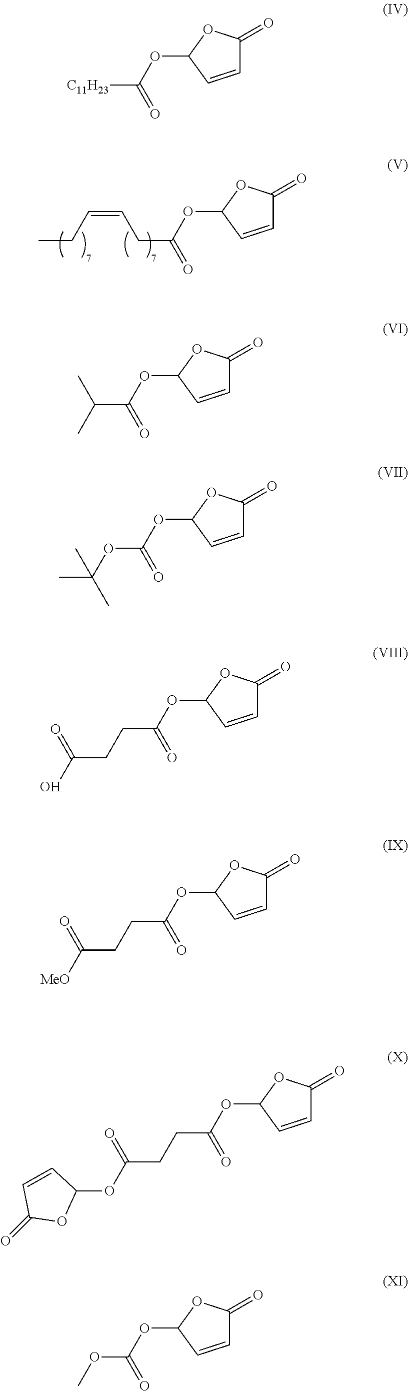

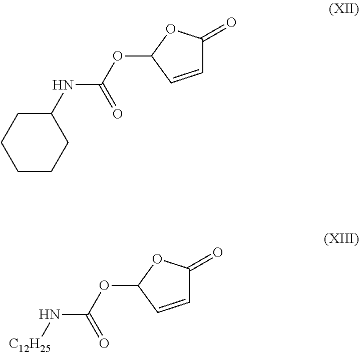

The disclosure is further illustrated by means of the following non-limiting examples.

### Examples

### Measurement Techniques

### Monomer Conversion and Initial Reaction Rate

### Method 1 (Monomer Conversion, Initial Reaction Rate by NMR):

A 40 μL sample was diluted in an NMR tube with CDCl₃ (550-600 μL) for reference. At various time points, 20-40 μL samples were taken from the reaction mixture with a microsyringe and diluted in an NMR tube with CDCl₃ (550-600 μL). All samples were analyzed by ¹H NMR on a 400 MHz spectrometer (typically D1=5, ns=8). After correcting processed spectra for phase and baseline, integration of relevant peaks (one for each monomer) allowed monitoring of conversion. Initial reaction rate was calculated from the sampling over time according to the method described in Hermens et al., Sci. Adv. 2020; 6: eabe0026.

### Method 2 (Monomer Conversion by Solids Content Measurement):

The solids content of the polymer solutions was determined in accordance with ISO 3251 with an initial sample mass of 1.0 g, test duration of 60 minutes, at a temperature of 125° C. The monomer conversion was calculated based on the measured solids content. Remaining monomers evaporated under the test conditions, whilst any polymer formed did not evaporate.

### Determination of Number Average Molar Mass (Mn) and Weight Average Molar Mass (Mw) by GPC

The number average and weight average molecular weights were determined using gel permeation chromatography (GPC) with tetrahydrofuran (THF) (+1% acetic acid) or 2-MeTHF as eluent (1 ml/min) on a styrene-divinylbenzene column using polystyrene standards for calibration.

The Poly Dispersity Index (PDI) is calculated by dividing the determined Mw over the determined Mn.

### Glass Transition Temperature (Ta)

Tg's were measured by Differential Scanning Calorimetry (DSC) using TA Instruments DSC Q2000 equipment in a modulated way according to ASTM D3418.

A DSC cup filled with 6+/−1 mg sample and an empty DSC reference cup were heated in the Differential Scanning Calorimeter (DSC) in a modulated way (+/−1° C. every 40 seconds) from −80° C. to 110° C. at 5° C./min in two consecutive runs using Helium (50 ml/min) as purge gas. Fourier transformation enables the separation of the modulated heat flow into a heat capacity component (Reversing Heat Flow) and a kinetic component (Non-reversing Heat Flow) allowing to separate different thermal events occurring at the same time.

At the materials Tg (observed in the reversing heat flow curve) the heat capacity of the material changed rapidly resulting in a strong decrease of the reversing heat flow curve over a certain transfer area. The Tg was calculated at the point of inflection (Tg(I)) for both runs.

The following vinyl ester and vinyl ether monomers were used:

| | |
|---|---|
| dodecyl vinyl ether | |
| vinyl neodecanoate (ex. Hexion) | VeoVa 10 |
| vinyl neononanoate (ex. Hexion) | VeoVa 9 |
| n-vinyl pyrrolidone | NVP |

The butenolide monomers with the following R¹ groups were used:
CH₃ (5-methoxy-2(5H)-furanone or “methoxy butenolide”)
C(O)CH₃ (5-acetoxy-2(5H)furanone or “acetoxy butenolide”)
C(O)CH(CH₃)₂(5-isobutyroxy-2(5H)furanone or “isobutyroxy butenolide”)
C(O)C(CH₃)₃(5-pivaloyloxy-2(5H)furanone or “pivaloyloxy butenolide”)
C(O)C₆H₅(5-benzoyloxy-2(5H)furanone or “benzoyloxy butenolide”)
C(O)C₁₁H₂₃ (5-dodecanoyloxy-2(5 h)furanone or “lauryloxy butenolide”)
C(O)C₇H₁₄C(H)═C(H)C₃H₁₇ (5-oleyloxy-2(5H)furanone or “oleyloxy butenolide”)
   where the double bond is cis
C(O)CH₂CH₂C(O)OH (5-succinyloxy-2(5H)furanone or “succinyloxy butenolide”)
C(O)CH₂CH₂C(O)OCH₃ (5-succinyloxy-2(5H)furanone methyl ester)
C(O)CH₂CH₂C(O) (bis(5-hydroxy-2(5H)furanone) succinate)
C(O)OCH₃ (5-hydroxy-2(5H)furanone methyl carbonate)
C(O)OC(CH₃) (5-hydroxy-2(5H)furanone tert-butyl carbonate)
C(O)NHC(H)C₆H₁₀ (5-hydroxy-2(5H)furanone cyclohexylcarbamate)
C(O)NHC₁₂H₂₅ (5-hydroxy-2(5H)furanone dodecylcarbamate)

The following solvents and reagents were used:

| | |
|---|---|
| dichloromethane | DCM |
| dimethylaminopyridine | DMAP |
| ethylacetate | AcOEt |
| tetrahydrofuran | THF |
| butyl acetate | BuAc |
| 1-methoxy-2-propanol (Dowanol ™ PM) | DowPM |
| N-methyl pyrrolidone | NMP |

The following initiators were used:

| | |
|---|---|
| t-butyl peroxy-3,5,5-trimethylhexanoate | T42S |

### Comparative Preparation Example 1

### Comparative Preparation Example 1

### Methoxy Butenolide

### 5-methoxy-2(5H)-furanone

Chemical Formula: C₅H₅O₃
Molecular Weight: 114.1000

This product and its synthesis were previously described in: Hermens et al., Sci. Adv. 2020; 6: eabe0026. 5-Hydroxy-2(5H)-furanone (100.0 g, 1 mol) was dissolved in 500 mL dry methanol and heated at reflux for 20 h. The conversion was followed by ¹H NMR until all 5-hydroxy-2(5H)-furanone was consumed. The solvent was evaporated under reduced pressure and the crude was distilled under reduced pressure (70° C., 1.0×10⁻² mbar) yielding 5-methoxy-2(5H)-furanone (86.5 g, 0.76 mol, 76%) as a slightly yellow oil.

### Preparation Examples 1-13

### Preparation Example 1

### Acetoxy Butenolide

### 5-oxo-2,5-dihydrofuran-2-yl acetate

Chemical Formula: C₆H₅O₄
Molecular Weight: 142.1100

This product and its synthesis were previously described in: G. C. Resende, E. S. Alvarenga, J. C. G. Galindo, F. A. Macias, J. Braz. Chem. Soc. 2012, 23 (12), 2266-2270. In a flask under N₂ atmosphere, hydroxy butenolide (1 eq., 500 mg, 5.00 mmol, grey solid) was dissolved in dry DCM (25 mL) and cooled to 0° C. with an ice bath. Acetic anhydride (1.6 eq., 754 (1 L, 7.99 mmol) was added, followed by a solution of DMAP (0.3 eq., 183 mg, 1.50 mmol) in dry DCM (1.5 mL). The mixture was stirred at 0° C. for 1 h and then allowed to warm up to RT. TLC (25% AcOEt/hexanes, rev. KMnO₄) showed formation of a new product at Rf=0.37. The clear solution was washed with water (25 mL). After phase separation, the aqueous layer was further extracted with DCM (25 mL). The combined organic extracts were dried with sodium sulfate, filtered on cotton and concentrated under reduced pressure. The residue was purified by automatic column chromatography (15 g SiO₂ cartridge, 10-40% AcOEt/pentane over 20 column volume (CV), using DCM for liquid injection. Concentration of the collected fraction afforded pure acetoxy butenolide as a colorless liquid (506 mg, 3.56 mmol, 71% yield).

### Preparation Example 2

### Isobutyroxy Butenolide

### 5-oxo-2,5-dihydrofuran-2-yl isobutyrate

Chemical Formula: C₈H₁₀O₄
Molecular Weight: 170.1640

In a flask under N₂ atmosphere, hydroxy butenolide (90 wt % pure, 1.50 eq., 6.67 g, 4.00 mmol) was dissolved in anhydrous DCM (40 mL, [acid]=1 M). Isobutyric acid (1.00 eq., 3.70 mL, 40.0 mmol) and DMAP (5 mol %, 244 mg, 2.00 mmol) were added. The clear mixture (blue due to hydroxy butenolide) was cooled to 0° C. with an ice bath. N,N′-Dicyclohexylcarbodiimide (DCC) (1.20 eq., 9.90 g, 48.0 mmol) was dissolved in anhydrous DCM (5 mL) and added dropwise at 0° C. over 5 min. After the addition, the ice bath was removed, and the mixture was stirred at room temperature for 1 h. The mixture turned from blue to dark brown with a precipitate. The reaction mixture was filtered on cotton wool, rinsing with DCM, affording a brown solid (urea) and a clear brown filtrate, which was concentrated in vacuo to a dark brown oil. The crude residue was purified by automatic column chromatography (80 g SiO₂ cartridge, 5-30% AcOEt/pentane over 15 CV), using DCM for liquid injection. Concentration of the collected fraction afforded pure isobutyroxy butenolide as a yellow oil (4.84 g, 28.4 mmol, 71% yield).

### Preparation Example 3

### Pivaloyloxy Butenolide

### 5-oxo-2,5-dihydrofuran-2-yl pivalate

Chemical Formula: C₉H₁₂O₄
Molecular Weight: 184.1910

Hydroxy butenolide (1 eq., 5.00 g, 50.0 mmol) was dissolved in dry DCM (25 mL) and cooled to 0° C. with an ice bath. This caused hydroxy butenolide to (partially) precipitate. Pivalic anhydride (1.2 eq., 12.2 mL, 60.0 mmol) was added, followed by a solution of DMAP (0.1 eq., 610 mg, 5.00 mmol) in dry DCM (2.5 mL). The mixture was first stirred at 0° C. for 30 min and was then allowed to warm up to RT, thereby causing full dissolution of the solids. The homogeneous mixture was further stirred at room temperature overnight (20 h in total). Over the course of the reaction, the initially blue mixture turned to dark green/brown. The reaction mixture was concentrated. The residue was purified by automatic column chromatography (80 g SiO2 cartridge, 5-30% AcOEt/pentane over 15 CV), using DCM for liquid injection. Concentration of the collected fraction afforded pure pivaloyloxy butenolide as a pale-yellow oil (6.74 g, 36.6 mmol, 73% yield).

### Preparation Example 4

### Benzoyloxy Butenolide

### 5-oxo-2,5-dihydrofuran-2-yl benzoate

Chemical Formula: C₁₁H₃O₄
Molecular Weight: 204.1810

This product was previously described in: B. M. Trost, F. D. Toste, J. Am. Chem] Soc. 2003, 125 (10), 3090-3100. Benzoyloxy butenolide was synthesized following a procedure adapted from: G. C. Resende, E. S. Alvarenga, J. C. G. Galindo, F. A. Macias, J. Braz. Chem. Soc. 2012, 23 (12), 2266-2270. In a flask under N₂ atmosphere, hydroxy butenolide (1 eq., 160 mg, 1.60 mmol) was dissolved in dry DCM (8 mL) and cooled to 0° C. with an ice bath. Benzoic anhydride (1.6 eq., 579 mg, 2.56 mmol) was added, followed by a solution of DMAP (0.3 eq., 59 mg, 0.48 mmol) in dry DCM (0.5 mL). The mixture was stirred at 0° C. for 1 h and then allowed to warm up to RT. Thin layer chromatography (25% AcOEt/hexanes, rev. KMnO4) showed formation of a new product at Rf=0.47. The clear solution was washed with water (15 mL). After phase separation, the aqueous layer was further extracted with DCM (15 mL). The combined organic extracts were dried with sodium sulfate, filtered on cotton and concentrated under reduced pressure. The residue was purified by automatic column chromatography (15 g SiO₂ cartridge, 0-30% AcOEt/pentane over 20 CV), using DCM for liquid injection. Concentration of the collected fraction afforded pure benzoyloxy butenolide as a white solid (236 mg, 1.16 mmol, 73% yield).

### Preparation Example 5

### Lauryloxy Butenolide

### 5-oxo-2,5-dihydrofuran-2-yl dodecanoate

Chemical Formula: C₁₆H₂₆O₄
Molecular Weight: 282.3800

Lauryloxy butenolide was synthesized following a procedure adapted from Guo, Chin. J. Chem. 2005, 23, 1683. A solution of lauric acid (1 eq., 1.00 g, 5.00 mmol) in anhydrous toluene (15 mL, [lauric acid]=0.33 M) was prepared in a reflux apparatus under N₂ and stirring was started. Thionyl chloride (6.5 eq., 2.4 mL, 3.9 g) was added at room temperature to the clear and colorless solution. The mixture was heated to reflux for 4 h, over which the reaction mixture turned yellow. The reaction mixture was then concentrated under vacuum (water bath=50° C.). The crude was re-dissolved in anhydrous toluene (15 mL) and hydroxy butenolide (1 eq., 500 mg, 5.00 mmol) was added to the resulting solution. The mixture was heated to reflux overnight. Upon heating, the initially insoluble hydroxy butenolide turned black and then dissolved. Thin layer chromatography [20% AcOEt/hexane, rev. KMnO4] showed appearance of a clear spot at Rf: 0.45, compared to hydroxy butenolide at Rf=0.20. After cooling down, the mixture was concentrated. The crude was purified by automatic column chromatography (15 g SiO₂ cartridge, AcOEt/pentane 0% to 25% over 20 CV), using DCM as solvent for liquid injection. Concentration of the collected fraction afforded pure lauryloxy butenolide as a white solid (925 mg, 3.28 mmol, 66% yield).

### Preparation Example 6

### Oleyloxy Butenolide

### 5-oxo-2,5-dihydrofuran-2-yl oleate

Chemical Formula: C₂₂H₃₆O₄
Molecular Weight: 364.5260

In a flask under N₂ atmosphere, hydroxy butenolide (1.00 eq., 1.00 g, 10.0 mmol) was dissolved in anhydrous DCM (20 mL, [SM]=0.5 M). Oleic acid (2.00 eq., 5.64 g, 20.0 mmol) in anhydrous DCM (2.5 mL) and DMAP (5 mol %, 61 mg, 0.50 mmol) were added. The clear mixture was cooled to 0° C. with an ice bath. DCC (1.20 eq., 2.47 g, 12.0 mmol) was dissolved in anhydrous DCM (2.5 mL) and added dropwise at 0° C. over 5 min. During the addition, a white precipitate formed. The slurry then slowly turned brown over time. After 30 min, the ice bath was removed and the mixture was stirred at room temperature for 1 h, until thin layer chromatography confirmed complete consumption of hydroxy butenolide.

The reaction mixture was filtered, rinsing with DCM, affording a white solid (urea) and a brown filtrate (ca. 50 mL), which was washed with sat. aq. NaHCO₃ (2×25 mL). The organic layer was dried with sodium sulfate, filtered and then concentrated in vacuo to a brown oil. The residue was purified by automatic column chromatography (40 g SiO₂ cartridge, 0-100% DCM/pentane over 20 CV), using hexanes for liquid injection. Concentration of the collected fraction afforded pure oleyloxy butenolide (950 mg, 2.61 mmol, 26% yield) as a yellow oil that solidifies around 15° C.

### Preparation Example 7

### Succinyloxy Butenolide

### 4-oxo-4-((5-oxo-2,5-dihydrofuran-2-yl)oxy)butanoic acid

Chemical Formula: C₈H₈O₆
Molecular Weight: 200.1460

Hydroxybutenolide (1 eq., 1.00 g, 9.99 mmol) was dissolved in dry DCM (20 mL) and cooled to 0° C. with an ice bath. Succinic anhydride (1.6 eq., 1.60 g, 16.0 mmol) was added, followed by a solution of DMAP (0.3 eq., 366 mg, 3.00 mmol) in dry DCM (1 mL). The mixture was first stirred at 0° C., during which it turned from light blue to light green, and was then allowed to warm up to room temperature overnight. In the morning the mixture had darkened even more. Thin layer chromatography (50% AcOEt/hexanes+1 vol % AcOH, rev. KMnO4) showed formation of a new, polar spot at Rf=0.25. The reaction mixture was concentrated. The residue was purified by automatic column chromatography (40 g SiO₂ cartridge, 10-60% AcOEt/pentane over 25 CV, then 60-100% over 5 CV), using DCM as solvent for liquid injection and adding 1 vol % AcOH in AcOEt. Concentration of the collected fraction afforded succinyloxy butenolide as a white solid (1.37 g) which still contained traces of succinic anhydride. Another purification by column chromatography (25 g SiO₂ cartridge, 10-60% AcOEt/pentane over 25 CV, then 60-100% over 5 CV), using solid injection (adsorbed in SiO₂) and adding 1 vol % AcOH in AcOEt, afforded pure succinyloxy butenolide (1.13 g, 5.63 mmol, 56% yield) as a white solid.

### Preparation Example 8

### Succinyloxy Butenolide Methyl Ester

### methyl (5-oxo-2,5-dihydrofuran-2-yl) succinate

Chemical Formula: C₉H₁₀O₆
Molecular Weight: 214.1730

In a flask under N_{z} atmosphere, succinyloxy butenolide (1.00 eq., 200 mg, 1.00 mmol) was dissolved in anhydrous DCM (5 mL, [SM]=0.2 M). Methanol (3.00 eq., 121 μL, 3.00 mmol) and DMAP (5 mol %, 6 mg, 0.05 mmol) were added. The hazy mixture was cooled to 0° C. with an ice bath. DCC (1.10 eq., 227 mg, 1.10 mmol) was added at once at 0° C. The mixture was stirred at 0° C. for 30 min and then at room temperature for 30 min.

The reaction mixture was filtered on a Büchner, rinsing with DCM, leaving a white solid and affording a brown filtrate which was concentrated to a brown murky oil. The residue was purified by automatic column chromatography (15 g SiO₂ cartridge, 10-50% AcOEt/pentane over 20 CV), using DCM for liquid injection. Concentration of the collected fraction afforded pure methyl succinyloxy butenolide (163 mg, 0.761 mmol, 76% yield) as a colorless semi-solid.

### Preparation Example 9

### Succinyloxy Bis-Butenolide

### bis(5-oxo-2,5-dihydrofuran-2-yl) succinate

Chemical Formula: C₁₂H₁₀O₈
Molecular Weight: 282.2040

In a flask under N₂ atmosphere, succinyloxy butenolide (1.00 eq., 500 mg, 2.50 mmol) and hydroxy butenolide (2.00 eq., 500 mg, 5.00 mmol) were dissolved in anhydrous DCM (20 mL, [SM]=0.125 M). DMAP (5 mol %, 15 mg, 0.13 mmol) was added. The clear mixture was cooled to 0° C. with an ice bath. DCC (1.20 eq., 618 mg, 3.00 mmol) was dissolved in anhydrous DCM (2 mL) and added dropwise at 0° C. over 5 min. During the addition, the hazy yellowish mixture first became clear yellowish, before turning back to hazy with the precipitation of a solid. The slurry then slowly turned brown over time. After 1 h, the ice bath was removed, and the mixture was stirred at room temperature for 1 h.

The reaction mixture was filtered, rinsing with DCM, affording a white solid (urea) and a clear brown filtrate, which was concentrated in vacuo to a brown solid. The residue was purified by automatic column chromatography (25 g SiO₂ cartridge, 0-20% AcOEt/pentane over 20 CV), using solid injection with neutralized silica. Concentration of the collected fraction afforded pure succinyloxy bis-butenolide (532 mg, 1.88 mmol, 75% yield) as a white solid.

### Preparation Example 10

### Methyl Carbonoxy Butenolide

### methyl (5-oxo-2,5-dihydrofuran-2-yl) carbonate

Chemical Formula: C₆H₅O₅
Molecular Weight: 158.1090

Methyl carbonoxy butenolide was synthesized following a procedure adapted from Zhang et al., Org. Lett. 2003, 5 (26), 5015. Hydroxybutenolide (1.00 eq., 500 mg, 5.00 mmol) was introduced in a 25 mL round bottom flask. An olive-shaped stirbar was added, the flask was capped with a rubber septum and placed under vacuum. After 5 minutes, the flask was backfilled with nitrogen, followed by two more vacuum-nitrogen cycles. Anhydrous DCM (10 mL, [SM]=0.5 M) was added and the mixture was vigorously stirred at room temperature (1000 rpm) until full dissolution of the solid. The clear solution was then cooled to −10° C. using a sat. NH₄Cl-ice bath. This caused the solution to become hazy, probably because hydroxybutenolide is not very soluble in DCM at this temperature. Methyl chloroformate (1.10 eq., 425 (1 L, 5.50 mmol) was added to the mixture at −10° C. with a syringe through the septum. Then DIPEA (1.20 eq., 1.00 mL, 6.00 mmol) was added dropwise with a syringe through the septum over 5 min. After the addition (during which the solution became yellow), the mixture was allowed to stir for 2 h, over which the temperature rose from −10° C. to 0° C. and the color turned from yellow to dark red. Thin layer chromatography (30% AcOEt/hexanes, rev. KMnO4) showed a new spot at Rf=0.45. The reaction mixture was diluted with DCM (10 mL) and washed with water (10 mL) twice. The red organic layer was dried with sodium sulfate, filtered and concentrated to afford a red crude oil. It was purified by automatic column chromatography (25 g SiO₂ cartridge, 10% to 50% AcOEt/pentane over 40 CV then 50% to 100% over 10 CV), using DCM for liquid injection. Concentration of the collected fraction afforded a 2:1 mixture of the desired product and methoxy butenolide as a near-colorless oil. Thin layer chromatography only showed one spot. Methoxy butenolide was removed by distillation under high vacuum (<1 mbar) on the rotovap overnight (water bath set at 60° C.). In the morning the methoxy butenolide had evaporated, leaving pure methyl carbonoxybutenolide as a pale light brown oil behind (278 mg, 1.76 mmol, 35% yield).

### Preparation Example 11

### Tert-Butyl Carbonoxy Butenolide

### tert-butyl (5-oxo-2,5-dihydrofuran-2-yl) carbonate

Chemical Formula: C₉H₁₂O₅
Molecular Weight: 200.1900

To a 50-mL round bottom flask were added hydroxy butenolide (1.0 eq. 1.00 g, 10.0 mmol) and an olive-shaped stir bar. The flask was placed under vacuum and gently heated, causing bubbling (likely residual solvent and water removal). The flask was back-filled with N₂ and dry DCM (20.0 mL, [SM]=0.5 M) was added. To the yellowish solution was added DMAP (25 mol %, 305 mg, 2.50 mmol), which dissolved rapidly. The solution was cooled to 0° C. with an ice bath and butoxycarbonyl (Boc) anhydride (1.5 eq., 3.4 mL, 15.0 mmol) was added dropwise over 5 min. No gas release was observed. The solution was stirred at 0° C. for 1 h. The ice bath was removed, allowing temperature to rise to room temperature. During the warming up process, an intense gas evolution suddenly occurred, along with a quick color change from yellowish to pink to red to brown. The gas release stopped after only a few minutes.

Sat. aq. NH₄Cl (25 mL) was added to the reaction mixture. The layers were separated and the organic one was washed once more with sat. aq. NH₄Cl (25 mL). The combined aqueous layers were extracted with DCM (25 mL). The combined organic extracts were washed with water (25 mL), dried with sodium sulfate, filtered and concentrated to a dark oil. The residue was purified by automatic column chromatography (40 g SiO₂ cartridge, 0-30% AcOEt/pentane over 15 CV), using DCM for liquid injection. Concentration of the collected fraction afforded pure tert-butyl carbonoxy butenolide (1.06 g, 5.27 mmol, 53% yield) as a pale oil that solidified overnight.

### Preparation Example 12

### Cyclohexyl Carbarnoxy Butenolide

### 5-oxo-2,5-dihydrofuran-2-yl cyclohexylcarbamate

Chemical Formula: C₁₁H₁₅NO₄
Molecular Weight: 225.2440

To a 25-mL round bottomed flask was added hydroxy butenolide (1.00 eq. 1.00 g, 10.0 mmol) and an olive-shaped stir bar. The flask was placed under vacuum and gently heated, causing bubbling (likely residual solvent and water removal). The flask was back-filled with N₂ and dry THF (10.0 mL, [SM]=1.0 M) was added. To the yellowish solution were added successively cyclohexyl isocyanate (1.10 eq, 1.4 mL, 11.0 mmol) and dibutyl tin dilaurate (1 mol %, 60 μL, 0.10 mmol). The reaction mixture was stirred at room temperature overnight, during which it turned to a murky brown. The reaction mixture was concentrated to a dark oil. The crude residue was purified twice by automatic column chromatography (40 g SiO2 cartridge, 10-50% AcOEt/pentane over 20 CV), using DCM for liquid injection. Concentration of the collected fraction afforded pure cyclohexyl carbarnoxy butenolide (820 mg, 3.64 mmol, 36% yield) as a colorless viscous oil.

### Preparation Example 13

### Dodecyl Carbarnoxy Butenolide

### 5-oxo-2,5-dihydrofuran-2-yl dodecylcarbamate

Chemical Formula: C₁₇H₂₉NO4
Molecular Weight: 311.4220

Dodecyl carbarnoxy butenolide (502 mg, 1.61 mmol) was prepared from hydroxy butenolide (500 mg, 5.00 mmol) in a similar way to Preparation Example 12 (cyclohexyl carbarnoxy butenolide), with a yield of 32% after purifying the residue twice by automatic column chromatography (25 g SiO₂ cartridge, 5-35% AcOEt/pentane over 40 CV), using DCM for liquid injection.

### Examples 1-14 and Comparative Examples 1, 2

To a screw cap 4-vial equipped with a 10 mm stirbar and a septum were added one of the Preparation Examples 1 to 13 and dodecyl vinyl ether (2 mmol in total), an internal standard (typically 1,3,5-trimethoxybenzene, 1 mmol) and a solvent (1-methoxypropan-2-ol, diethylcarbonate or butyl acetate, 500 μL, [monomers]=4 M).

The mixture was homogenized, briefly heating if needed (e.g. in case of insoluble monomers), and then a 40 μL sample was diluted in an NMR tube with CDCl₃ (550-600 μL) for reference. The vial was then closed and pre-heated at 120° C. for 1-2 min. Trigonox 42S (60 μmol, 3 mol % versus monomers) was added to the hot mixture via a microsyringe through the septum, corresponding to t=0. At various time points, 20-40 μL samples were taken from the reaction mixture with a microsyringe and diluted in an NMR tube with CDCl₃ (550-600 μL).

The polymers were analyzed by gel permeation chromatography in THF or 2-MeTHF, with detection by refraction index against a polystyrene calibration.

Monomer conversion and initial reaction rate were calculated according to Method 1, described above.

TABLE 1

| | Butenolide monomer | | | Initial | | | |
|---|---|---|---|---|---|---|---|
| Example | Preparation | | | rate | Monomer | Mₙ | |
| No. | Example No. | Structure | Solvent | [10⁻³ s⁻¹] | conversion | [kDa] | PDI |
| Comp. Ex. 1 Comp. Ex. 2 | C. Prep. Ex. 1 | 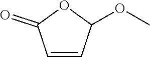 | 1M2P AcOBu | 1.4 0.6 | 95% 95% | 1.6 1.3 | 3.0 2.2 |
| Ex. 1 Ex. 2 | Prep. Ex. 1 | 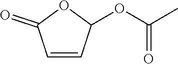 | 1M2P AcOBu | 3.4 2.1 | 93% 95% | 1.8 2.2 | 2.8 3.1 |
| Ex. 3 | Prep. Ex. 2 | 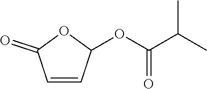 | AcOBu | 1.9 | 99% | 2.0 | 2.9 |
| Ex. 4 | Prep. Ex. 3 | 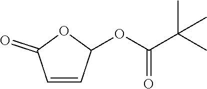 | AcOBu | 2.3 | 95% | 2.7 | 3.5 |
| Ex. 5 Ex. 6 | Prep. Ex. 4 | 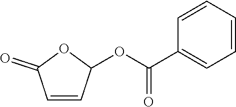 [SMILES: O=C1C=CC(OC(=O)c2ccccc2)O1] | 1M2P AcOBu | 4.5 3.7 | 97% 96% | 2.0 2.7 | 3.5 |
| Ex. 7 Ex. 8 | Prep. Ex. 5 | 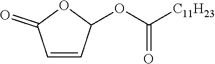 | 1M2P AcOBu | 3.1 2.4 | 94% 95% | 1.2 2.8 | 3.1 3.0 |
| Ex. 9 | Prep. Ex. 6 | 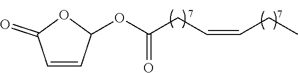 | AcOBu | 0.7 | 91% | 3.3 | 1.0 |
| Ex. 10 | Prep. Ex. 8 | 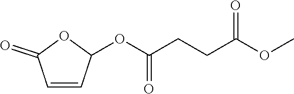 | AcOBu | 2.9 | 95% | 2.7 | 2.5 |
| Ex. 11 | Prep. Ex. 10 | 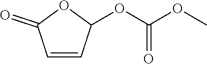 | AcOBu | 2.1 | 88% | 2.0 | 4.0 |
| Ex. 12 | Prep. Ex. 11 | 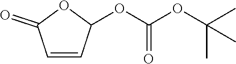 | AcOBu | 1.7 | 93% | 2.3 | 2.9 |
| Ex. 13 | Prep. Ex. 12 | 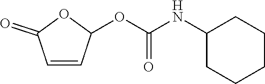 [SMILES: O=C1C=CC(OC(=O)NC2CCCCC2)O1] | AcOBu | 1.2 | 94% | 1.9 | 3.5 |
| Ex. 14 | Prep. Ex. 13 | 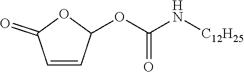 | AcOBu | 1.2 | 80% | 8.4 | 1.4 |

The results indicate that a wide variety of butenolide monomers can be co-polymerized using radical initiation. In addition, polymers of Ex. 1 to Ex. 14 have variously higher initial rate of polymerization, higher conversion, higher number average molecular weight (Mn) or higher polydispersity index (PDI) than Comp. Ex. 1 or Comp Ex. 2.

### Examples 15, 16, 17 and Comparative Examples 3, 4

Binder polymers were prepared by charging butenolide monomer and Dowanol PM in a three-neck round-bottom flask equipped with a reflux condenser. The mixture was heated to a temperature of 125° C. and vinyl monomer and t-butyl peroxy-3,5,5-trimethylhexanoate (Trigonox 42S, ex. Nouryon) in further Dowanol PM was dosed in two hours whilst keeping the temperature at 125° C. under reflux conditions under a nitrogen blanket. Some further initiator was then added, and the reaction continued for one hour; then still further initiator was added and the reaction continued for another hour. The reaction mixture was cooled to room temperature. The calculated solids content (weight of monomers and initiator based on total weight of monomers, initiator, and solvent) was 43 wt %. The molar ratio of butenolide monomer to vinyl monomer was in each case 1:1.

In Table 2 is shown for the different binder polymers prepared and the measured properties (monomer conversion, Tg, and molecular weight distribution). Monomer conversion was measured according to Method 2 described above.

A 200 μm wet film of each of Ex. 16 and C. Ex. 4 was drawn on a glass plate using a drawing bar. The wet film was allowed to dry at 23° C. and 50% relative humidity for 7 days. A tack-free, transparent coating was obtained. Pendulum hardness (Persoz hardness) was determined according to ISO 1522. The time for the amplitude of the pendulum to decrease from 12 to 4 degrees was measured.

TABLE 2

| | Butenolide | | | | | | | | Persoz |
|---|---|---|---|---|---|---|---|---|---|
| | monomer | | | Monomer | | | | | hardness |
| Example | Prep. | | Vinyl | conversion | Tg | | | | time |
| No. | Ex. No. | Name | monomer | [%] | [C°] | Mn | Mw | PDI | [s] |
| Ex. 15 | Prep. | Acetoxy | VEOVA 10 | 99 | −29 | 772 | 1484 | 1.9 | * |
| | Ex. 1 | butenolide | | | | | | | |
| Ex. 16 | Prep. | Acetoxy | VEOVA | 100 | 9 | 773 | 1440 | 1.9 | 16 |
| | Ex. 1 | butenolide | 9/10 (1:1) | | | | | | |
| Ex. 17 | Prep. | Acetoxy | N-vinyl- | 100 | 88 | 743 | 1333 | 1.8 | ** |
| | Ex. 1 | butenolide | pyrrolidone | | | | | | |
| C. Ex. 3 | C. Prep. | Methoxy | VEOVA 10 | 96 | 1 | 955 | 2019 | 2.1 | * |
| | Ex. 1 | butenolide | | | | | | | |
| C. Ex. 4 | C. Prep | Methoxy | VEOVA | 95 | — | 1007 | 2201 | 2.2 | 60 |
| | Ex. 1 | butenolide | 9/10 (1:1) | | | | | | |

* formed a tacky film - Persoz hardness not tested
** no film formation occured - Persoz hardness not tested

These examples show that the Ex. 15 to 17 have increased monomer conversion when using the same synthetic procedure as C. Ex. 3 and 4 without affecting the molecular weight distribution. The binder polymer film can form a coating that is tack-free, the hardness of the coating can be modified by the selection of the co-monomer (blend). Further a tack-free film could be produced from Ex. 16; it had an adequate Persoz hardness.

1. A coating composition comprising a binder polymer, which binder polymer is obtainable by copolymerizing a monomer mixture comprising a vinyl monomer M1 and a butenolide monomer M2,
wherein the vinyl monomer M1 has a difference in ¹³C chemical shift between the α-C and β-C of the vinyl group of at least 25 ppm,
and wherein the butenolide monomer M2 is a substituted-5-hydroxy-2(5H)-furanone of general formula (I): 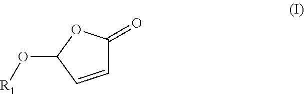
wherein R¹ is any one of:
—C(O)R², —C(O)OR², —C(O)NR²R³, —S(O)R², —S(O₂)R², —C(O)SR², —C(S)SR² and —C(S)NR²R³,
wherein R² is alkyl or aryl, and wherein R³ is hydrogen, alkyl or aryl, or wherein R² and R³ together with the nitrogen atom through which they are linked form a nitrogen-containing cyclic heteroalkyl group or nitrogen-containing heteroaryl group; and
wherein the difference in ¹³C chemical shift between the α-C and β-C of the vinyl group is determined from the chemical shift reported in the Spectral Database for Organic Compounds (https://sdbs.db.aist.go.jp/sdbs/cgi-bin/direct_frame_top.cgi), managed by the National Institute of Advanced Industrial Science and Technology.

2. The coating composition according to claim 1, wherein the vinyl monomer M1 is:
a vinyl compound of general formula (II) 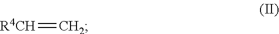
wherein R⁴ is any one of:
—OR⁵, —OC(O)R⁵, —N(R⁶)C(O)R⁵, —N(R⁶)C(O)OR⁵, —NR⁶C(S)R⁵, —NR⁶C(S)OR⁵, —NR⁶C(S)SR⁵ and —SC(S)SR⁵,
wherein R⁵ is alkyl or aryl, and wherein R⁶ is hydrogen, alkyl or aryl, or wherein R⁵ and R⁶ together with the atoms through which they are linked form a nitrogen-containing cyclic heteroalkyl group or nitrogen-containing heteroaryl group.

3. The coating composition according to claim 2, wherein R⁴ is —OR⁵, —OC(O)R⁵ or —N(R⁶)C(O)R⁵.

4. The coating composition according to claim 1, wherein M1 is n-butyl vinyl ether, iso-butyl vinyl ether, cyclohexyl vinyl ether, phenyl vinyl ether, 2-ethylhexyl vinyl ether, n-dodecyl vinyl ether, 4-hydroxybutyl vinyl ether, vinyl neodecanoate, vinyl neononanoate, N-vinylpyrrolidone, N-vinyl imidazole, N-vinyl-formamide, N-vinyl-pyrrole, N-vinylcaprolactam or a mixture of two or more thereof.

5. The coating composition according to claim 1, wherein R¹ is any one of —C(O)R², —C(O)OR², —C(O)NR²R³.

6. The coating composition according to claim 1, wherein R² is C₁-C₂₀ alkyl, C₅-C₇ cycloalkyl or phenyl.

7. The coating composition according to claim 1, wherein R³ is hydrogen.

8. The coating composition according to claim 1, wherein the monomer mixture comprises vinyl monomer M1 and butenolide M2 in a molar ratio in the range of from 1:5 to 5:1.

9. The coating composition according to claim 1, which coating composition is an aqueous liquid coating composition comprising a binder polymer, emulsified in an aqueous phase.

10. A substrate coated with a coating deposited from a coating composition as defined in claim 1.

11. A binder polymer obtainable by copolymerizing a monomer mixture comprising a vinyl monomer M1 and a butenolide monomer M2, said monomer mixture as defined in claim 1.

12. The binder polymer according to claim 11, wherein the vinyl monomer M1 has a difference in ¹³C chemical shift between the α-C and β-C of the vinyl group of at least 25 ppm
and wherein the butenolide monomer M2 is a substituted-5-hydroxy-2(5H)-furanone of general formula (I): 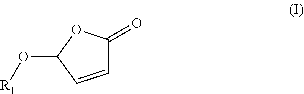
wherein R¹ is any one of:
—C(O)OR², —C(O)NR²R³, —S(O)R², —S(O₂)R², —C(O)SR², —C(S)SR², —C(S)NR²R³ and —C(O)R¹¹,
wherein R² is alkyl or aryl, R³ is hydrogen, alkyl or aryl, or wherein R² and R³ together with the nitrogen atom through which they are linked form a nitrogen-containing cyclic heteroalkyl group or nitrogen-containing heteroaryl group, and wherein R¹¹ is aryl or C₂-C₂₀ alkyl.

13. The binder polymer according to claim 12 wherein the vinyl monomer M1 is:
a vinyl compound of general formula (II) 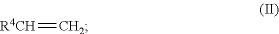
wherein R⁴ is any one of:
—OR⁵, —N(R⁶)C(O)R⁵, —N(R⁶)C(O)OR⁵, —NR⁶C(S)R⁵, —NR⁶C(S)OR⁵, —NR⁶C(S)SR⁵, —SC(S)SR⁵ and —OC(O)R¹²,
wherein R⁵ is alkyl or aryl, R⁶ is hydrogen, alkyl or aryl, or wherein R⁵ and R⁶ together with the atoms through which they are linked form a nitrogen-containing cyclic heteroalkyl group or nitrogen-containing heteroaryl group, and wherein R¹² is aryl or C₂-C₂₀ alkyl.

14. A butenolide monomer which is a substituted-5-hydroxy-2(5H)-furanone of general formula (III): 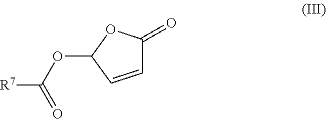
wherein R⁷ is any one of:
C₂-C₂₀ alkyl, —OCHR⁸R⁹, —NR⁸R⁹, —SR⁹, wherein R⁸ is alkyl or aryl, and wherein R⁹ is hydrogen, alkyl or aryl, or when R⁷ is —NR⁸R⁹, R⁸ and R⁹ together with the nitrogen atom through which they are linked from a nitrogen-containing cyclic heteroalkyl or nitrogen-containing heteroaryl group.

15. The butenolide monomer according to claim 14, which butenolide monomer is a compound of any one of formula (IV) to (XIII): 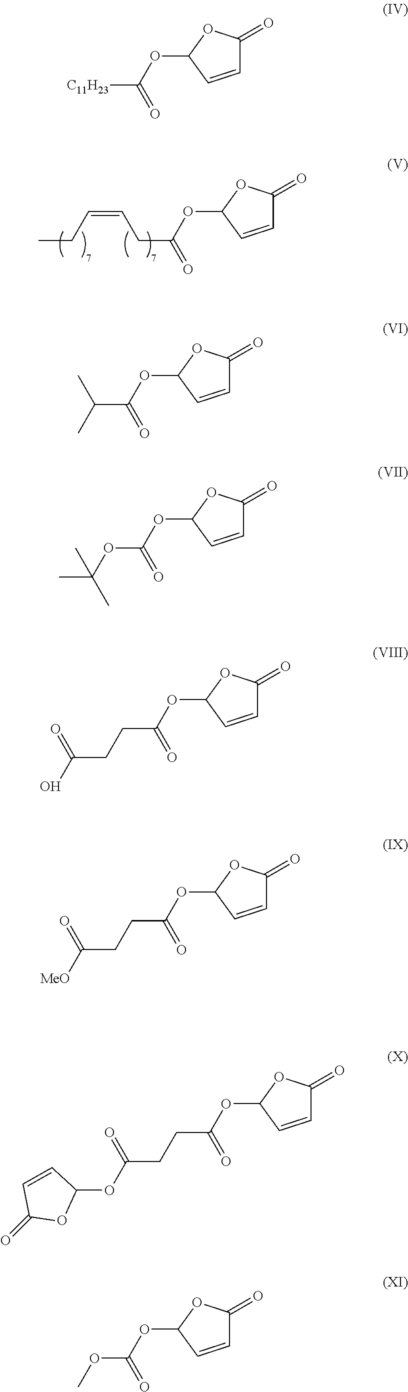 [chemical structure]
